(19) United States
(12) Patent Application Publication
(10) Pub. No.: US 2009/0246436 A1
(43) Pub. Date: Oct. 1, 2009

(54) Single-use thermoforming tool and method

(76) Inventors: Mary B. Gorin, Louisville, KY (US); Lawrence W. Gorin, Louisville, KY (US)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(21) Appl. No.: 12/383,397

(22) Filed: Mar. 24, 2009

Related U.S. Application Data
(60) Provisional application No. 61/072,050, filed on Mar. 27, 2008.

(51) Int. Cl. B44C 1/28; B44C 5/00; B29C 33/38

(52) U.S. Cl. 428/39; 156/59; 264/219

(57) ABSTRACT

The present invention relates to an image in relief created by thermo, pressure or vacuum forming a sheet of printed, clear or opaque plastic, styrene, PVC, PET or any similar material capable of forming and holding a form against stacked levels of die cut (or pre-cut) materials (the tool or pattern), one on top of another. The tool is left inside the relief cavity to provide structure, making it durable and therefore commercially viable for one-off, personalized relief images.

This application claims the benefit of U.S. provisional patent application Ser. No. 61/072,050, filed Mar. 27, 2008, for single use thermoforming tool and method.

### BACKGROUND OF THE INVENTION

(a) Field of the Invention

The present invention relates to a relief image and a method for making said relief image, created by thermo, pressure or vacuum forming a sheet of printed, clear or monochromatic styrene, PVC, PET, plastic, polymer or any material capable of forming and holding a form against a molding tool composed of stacked levels of die cut materials, one on top of another. The molding tool is left inside the relief cavity to provide structure, making it durable and therefore commercially viable. The tool creates a low-cost, single-use relief pattern.

(b) Background of the Invention

The thermoforming process is a process by which a thermoplastic sheet or film is heated between infrared, natural gas, or other heaters to its forming temperature and molded over a temperature-controlled, single-surface molding tool. Customarily, the same tool is used over and over again to produce multiple relief images. Typically, durable, rigid, costly materials such as cast or machined aluminum, epoxy, hard resins, and wood materials are used to create the molding tool in order to withstand thousands of thermoforming cycles. Due to the high costs associated with tool making and thermoforming, the process has generally been relegated to large projects ranging from thousands to millions of units. Furthermore, the process typically requires someone with high technical skills familiar with CAD/CAM software programs and is expensive. The expertise needed typically results in time consuming, high billable hours. Even hand crafting or sculpting molding tools can be time consuming and somewhat expensive. The expense of producing a molding tool prevents the creation of “one-of-a-kind” personalized relief images for the average consumer. A need exists for creating single-use relief images using low-cost, disposable components.

The Inventor is not aware of any prior art addressing the problem of a single use relief image and tool.

### SUMMARY OF THE INVENTION

The present invention addresses the shortcomings of the prior art and provides for, among other things, a low cost single-use, three dimensional print.

The molding tool of the present invention uses low-cost, disposable materials such as cardboard, dense foam, plastic, wood, among other similar materials capable of being formed against. The materials are preferably cut from a single substrate in one or more layers based on the desired projection of the elements in a base image. The layers are stacked upon one another with the rearmost layer being at the base and the foremost layer being at the top. Preferably layers are numbered once they are outlined and cut from the substrate to simplify the making of the molding tool. Each layer is adhered to the layer above and below it using any means of adhesion, such as glue.

A thermoplastic or polymer sheet or film that is printed, clear or opaque is preferably used. The thermoplastic sheet or film is then covered in a material such as a laminate or coating to protect the inks during and after the thermoforming process. The thermoplastic or polymer sheet or film is then heated between infrared, natural gas, or other heaters to reach its forming temperature. The thermoplastic sheet or film is then molded over the molding tool to form a relief cavity. In producing “one-of-a-kind” personalized relief images, the tool remains inside the relief cavity to provide structure, adding durability and value to the relief image.

The purpose of the present invention is to provide quick, affordable three-dimensional prints for the average consumer. The present invention utilizes a simple software program that allows one to trace and cut elements or vectors of a two-dimensional image to create a three-dimensional relief image. The process also provides for a quick, low cost mechanism for rapid prototyping, as opposed to known, more expensive techniques, which require expertise with vectors, tool paths, etc. The process for creating a single-use molding tool comprises selecting a base image, indicating one or more elements at least partially corresponding to the base image, cutting a substrate to correspond with the one or more elements, repeatedly indicating elements and cutting substrate for each of one or more layers of substrate, wherein the indicated elements for each layer of substrate are a subset of the elements indicated for the previous layer of substrate, aligning and stacking the one or more layers of substrate, and adhering together the one or more layers of substrate. Even more particularly, the substrate is an inexpensive, disposable material, such as cardboard, foam, plastic, or wood.

In another embodiment, the present invention is a decoration comprising a molding tool and a thermoplastic material. More particularly, the molding tool comprises one or more layers of elements, the elements substantially corresponding to at least a portion of a base image. Even more particularly, at least a portion of the thermoplastic material is raised and formed into contours of varying elevations, the contours substantially corresponding to the molding tool.

In yet another embodiment, the present invention is a method of producing a relief image, wherein a user will indicate one or more elements of a base image to be in relief, indicate a subset of the one or more elements of the previous step to be in relief from the one or more elements of the previous step, repeat the previous step until all elements corresponding to the desired relief image are indicated, cut each element from a substrate, align, stack, and attach each of the one or more elements atop the one or more elements of the previous step, forming a molding tool, align the molding tool on a backer, print the base image on a material capable of forming and holding a form, align the base image on the material capable of forming and holding a form with the molding tool, form the material capable of forming and holding a form against the molding tool, and attach the material capable of forming and holding a form to the backer using an attachment means, whereby the molding tool is retained between the material capable of forming and holding a form and the backer. More particularly, the material capable of forming and holding a form is plastic, styrene, PVC, PET, or a polymer. Even more particularly, the material capable of forming and holding a form is laminated or coated.

### BRIEF DESCRIPTION OF THE DRAWINGS

A better understanding of the present invention will be had upon reference to the following description in conjunction with the accompanying drawings, wherein:

FIG. 1 shows the multiple layers of the relief image of the present invention;

FIG. 2 shows the process of creating the molding tool;

FIG. 3 shows the process of forming the relief image;

FIG. 4 shows a base photo from which a relief image will be made;

FIG. 5 shows an outline of a first layer of the molding tool;

FIG. 6 shows an outline of a second layer of the molding tool;

FIG. 7 shows an outline of a third layer of the molding tool;

FIG. 8 shows an outline of a fourth layer of the molding tool;

FIG. 9 shows an outline of a fifth layer of the molding tool;

FIG. 10 shows an outline of a sixth layer of the molding tool;

FIG. 11 shows an outline of a composite of the layers of FIGS. 5-10 stacked to created the molding tool; and

FIG. 12 shows another view a composite of the layers of FIGS. 5-10 stacked to create the molding tool.

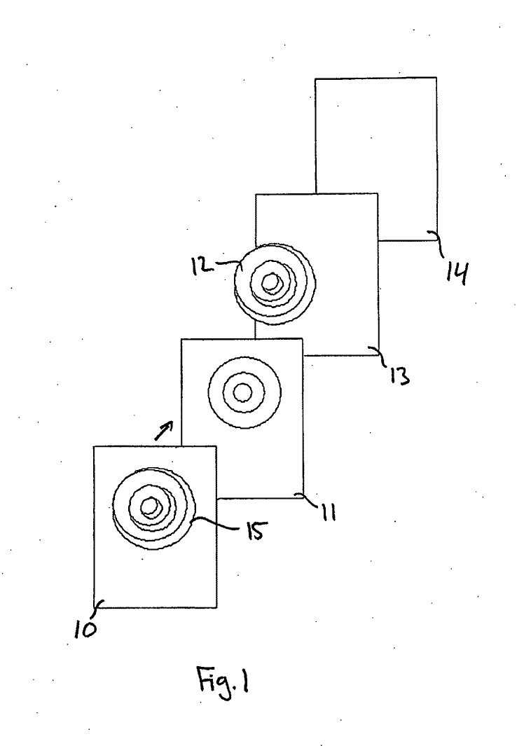

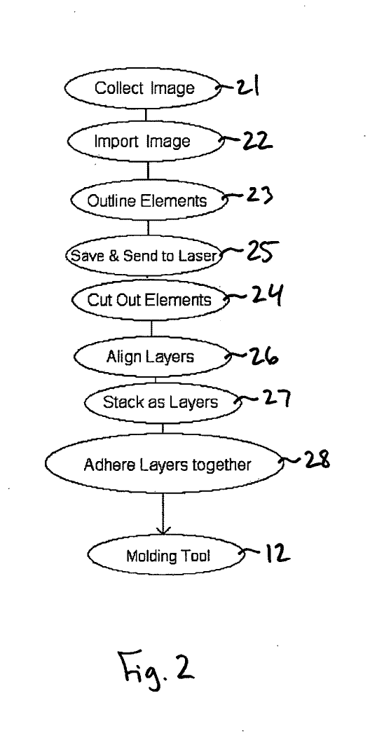

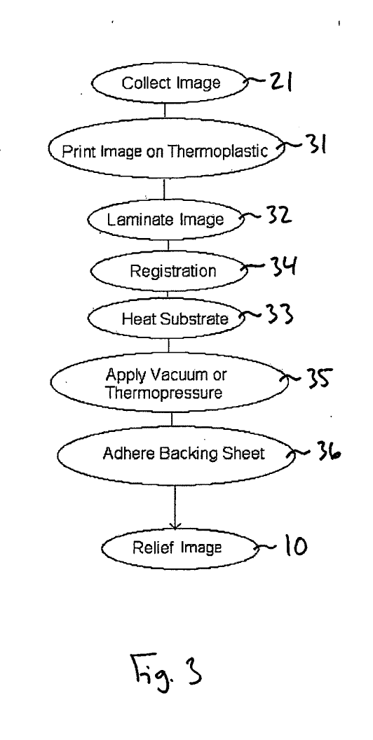

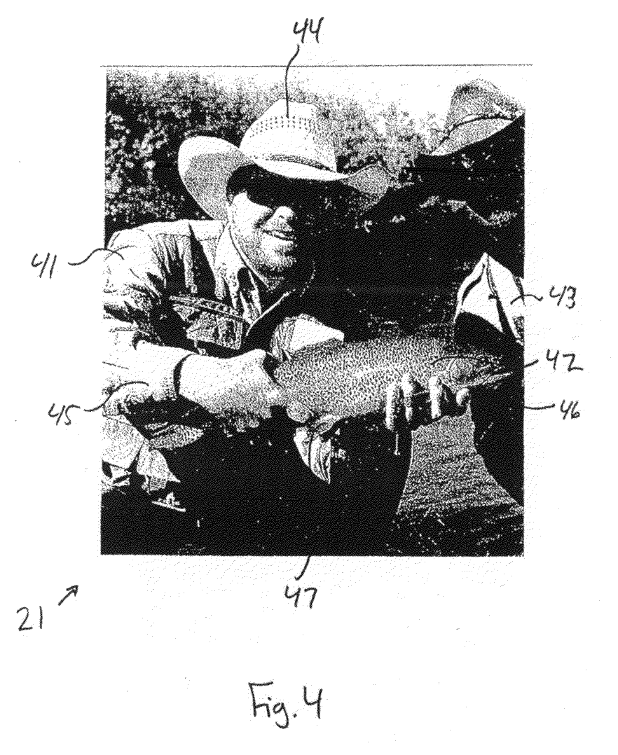

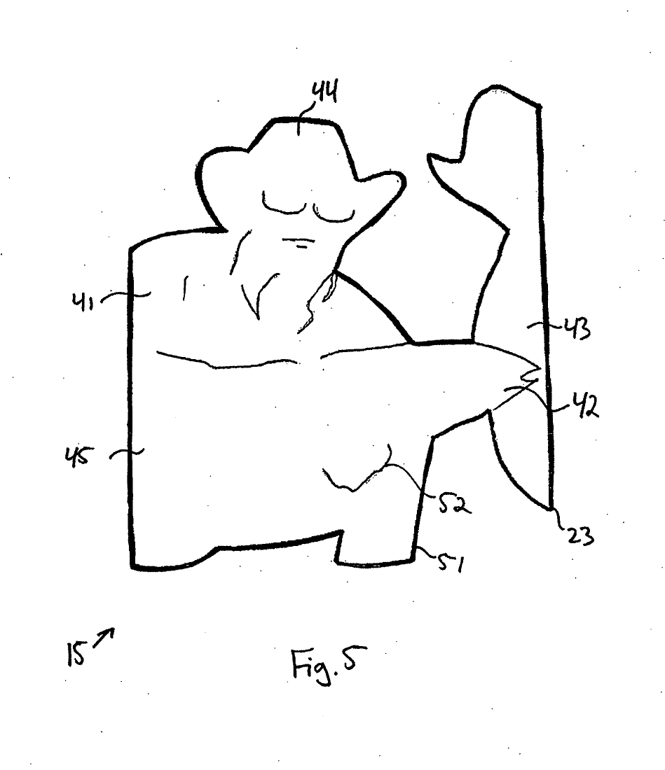

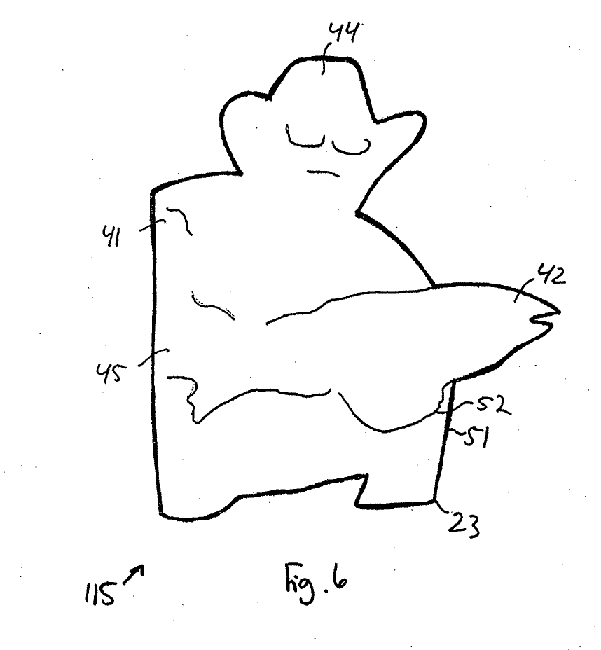

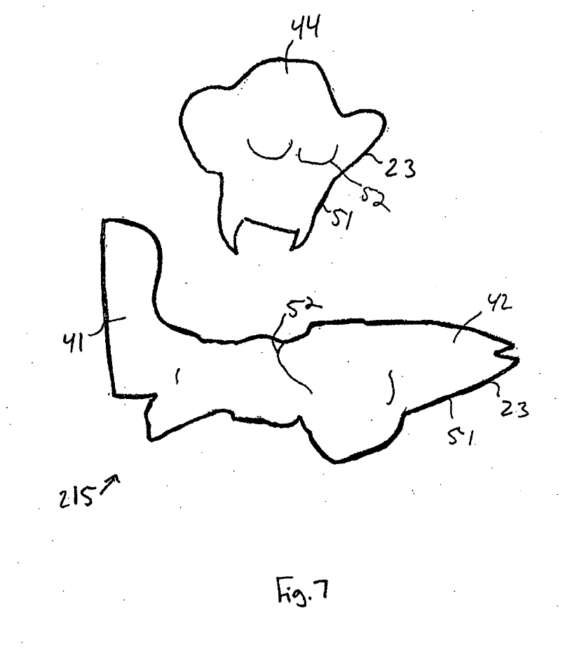

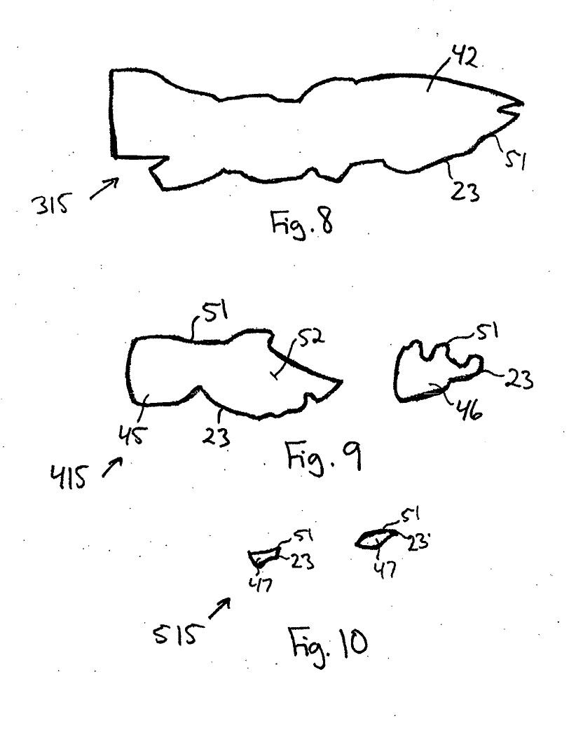

### DETAILED DESCRIPTION OF THE PREFERRED EMBODIMENT

With reference to the figures, the relief image 10 of the present invention comprises a thermoplastic 11 or polymer sheet or film, an adhesive 13, a molding tool 12, and a backing material 14. The thermoplastic 11 or polymer may be any type, such as styrene, PVC or PET, capable of being molded through use of a heating element 33, a molding tool 12, and a molding means 35, such as temperature, pressure, or a vacuum.

Initially, a base image 21 from which a relief image 10 is to be made is imported 22 into a computer. An outline of the elements 23 is created of each of the elements 23 of the base image 21 for which the relief is desired. Image elements 23 may be outlined manually, or through software applications such as CorelDraw® or Adobe Photoshop®, saved and sent 25 to the laser for cutting. In a preferred embodiment, the outline of the elements 23 will have varied widths based upon the purpose of the line. For example, if the line is intended to be cut for the layer, it may be of a thicker width 51, whereas a line intended for the purposes of alignment may be a more narrow width 52. Alternatively, lines 51 and 52 can be distinguished in other ways, such as by color, dashed, or dotted lines.

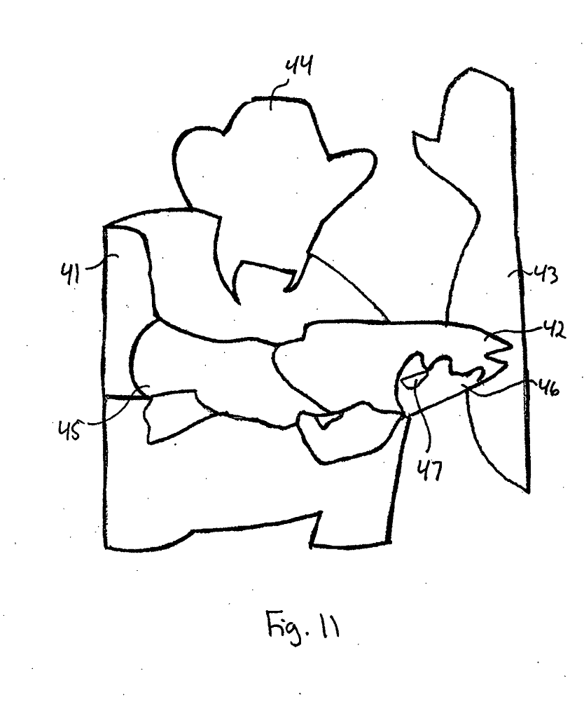

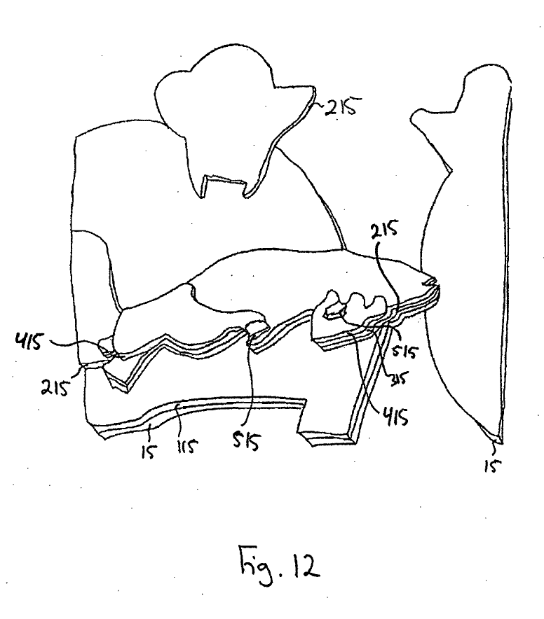

A relief image 10 will have multiple layers as a function of the elements 23 in the base image 21 and client preferences. A first layer 15 consists of a total relief area (i.e., the entire subject of the relief image). Each additional layer will be created in the same manner as the first, except that the elements 23 being outlined will vary based further upon the elements 23 of the base image 21 and client preferences. Each layer 15, 115, 215, 315, 415, 515 represents a farther projection of the elements 23 into three dimensional space. Referring to FIG. 4, the base image 21 is of a man holding a fish standing next to a second man. A user can determine individual elements 23 of the base image 21 that would give the base image 21 a natural three dimensional appearance. By projecting certain elements 23 of an image, a degree of realism can be obtained. FIG. 5 shows the first layer 15 as an outline of the man 41 holding the fish, the fish 42, and the second man 43 standing next to the man 41 holding the fish. FIG. 6 shows the second layer 115 as a further outline of the man 41 holding the fish and the fish 42. FIG. 7 shows the third layer 215 as a further outline of the head 44, right arm 45 and left hand 46 of the man 41 holding the fish, and the fish 42. FIG. 8 shows the fourth layer 315 as a further outline of the fish 42. FIG. 9 shows the fifth layer 415 of the right arm 45 and left hand 46 of the man 41 holding the fish. FIG. 10 shows the sixth layer 515 of outlines of the fins 47 of the fish. FIG. 11 shows a top view of each layer 15, 115, 215 & 315 as the overlay of FIGS. 5-10 to create the molding tool 12. FIG. 12 shows an angular view of the composite of FIG. 11, showing the three dimensions of the molding tool 12.

FIG. 5-10 consist of both thick, dark lines 51 and narrow, light lines 52. The thick, dark lines 51 are used as an indication that the substrate is to be cut there along to create the layer. The narrow, light line 52 is used as a means to assist alignment 26 of the layers 15 during the stacking 27 process. In a preferred embodiment, a laser cutting device, such as, for example, an Epilog® laser, is capable of receiving instructions based on line width, and will cut 24 the substrate all the way through, or using a “kiss cut” method, along line widths of a thickness range determined by the user and will partially cut 24, or “etch” the substrate along line widths not within that range. A kiss cut is a technique where the cut is completely through the substrate and adhesive up to, but not including an adhesive backing liner. The narrow, light lines 52 should be significant lines of the base image to aid the alignment of important features. Template of cut-out elements of the image may also be used to assist in the alignment of certain layers during the stacking 27 process.

Once the layers 15, 115, 215, 315, 415, 515 are cut, the layers 15, 115, 215, 315, 415, 515 should be aligned 26, stacked 27 and adhered 28 together, until the entire molding tool 12 is created. The order of the outlined layers 15, 115, 215, 315, 415, 515 should begin with the entire outlined area as the base layer 15, followed by continually more projected layers, until the final layer 15 is the foremost layer 515, comprised of the foremost elements 23 in the base image 21. Each layer 15, 115, 215, 315, 415, 515 should generally, but not necessarily, be cut 24 from the same substrate to minimize costs and ensure consistency in the molding tool 12. The substrate should be a lost-cost, disposable material such as cardboard, dense foam, plastic, or wood. Depending upon the substrate used to create the molding tool 12 (i.e. rigid polymer or thin flexible wood), layers 15, 115, 215, 315, 415, 515 could be shaved or sanded to create modeling or rounding if desired.

In a preferred embodiment, the base image 21 is then printed 31 in color (if desired) on a thermoplastic 11 or polymer sheet or film such as 15 ml styrene and in black and white on a printable substrate such as card stock. A cost-effective way to do this would be through digital printing with the use of an HP Indigo Printer or Xerox iGen. In an alternative embodiment, the molding tool may be used to thermoform a thermoplastic or polymer sheet or film without a printed base image, wherein the projection of the layers create the image. Preferably, the styrene will be laminated 32 or coated to protect any inks of the base image.

Corner guides or holes are punched into card stock and printed thermoplastic 11 for sheet or pin registration 34 on thermoforming equipment. The card stock or other printed substrate is placed on a platen using pin registration 34. A platen is typically a flat metal plate having holes to allow vacuum suction. A registration pin 34 or corner guide is a device intended to hold a piece of film, paper or other material in place. Registration pins 34 or corner guides are used in the thermoforming process, in order to accurately position the different films or plates for multi-layer work.

The layers are stacked and aligned using the registration pin or corner guides and the printed image on card stock. A non-printed sheet of card stock, or template, with a cut-out of the image to be formed in relief, could serve as an alternative means of aligning the tool. The printed styrene is formed 34 with the print side up on top of molding tool using pin registration to form the printed styrene relief image. A molding means 35, such as a vacuum, thermo, or pressure is then applied to create a tight fit of the thermoplastic 11 around the molding tool 12. Once registered and formed, any excess portion of the thermoplastic 11 or polymer is cut away and the molding tool 12 is left in back of printed styrene 11 to serve as its structure. An adhesive 13, such as a pressure sensitive adhesive (PSA) is placed on a separate card stock 14 or other material backing to adhere 36 the card stock 14 to the styrene 11, and being adhered 36 in such as fashion as to prevent movement of the molding tool 12 inside the relief image 10. The PSA 13 in the present invention may be a sheet adhesive or, alternatively, just an adhesive coating. Alternatively, the molding tool 12 can be left out of the relief image for a hollow thermoform relief image.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A process for creating a single-use molding tool, comprising:
a. selecting a base image;
b. indicating one or more elements at least partially corresponding to said base image;
c. cutting a substrate to correspond with said one or more elements;
d. repeating steps b & c for each of one or more layers of substrate, wherein the indicated elements for each layer of substrate are a subset of the elements indicated for the previous layer of substrate;
e. aligning and stacking said one or more layers of substrate; and
f. adhering together said one or more layers of substrate.

2. The process for creating a single-use molding tool of claim 1, wherein said substrate is an inexpensive, disposable material.

3. The process for creating a single-use molding tool of claim 2, wherein said material is cardboard, foam, plastic, or wood.

4. The process for creating a single-use molding tool of claim 1, wherein said substrate includes an adhesive backing liner.

5. A decoration, said decoration comprising:
a molding tool, wherein said molding tool comprises one or more layers of elements, said elements substantially corresponding to at least a portion of a base image;
a thermoplastic material, wherein at least a portion of said thermoplastic material is raised and formed into contours of varying elevations, said contours substantially corresponding to the molding tool.

6. The decoration of claim 5, wherein said base image is printed on said thermoplastic material

7. The decoration of claim 6, wherein said thermoplastic material is laminated.

8. The decoration of claim 5, wherein said thermoplastic material is a polymer.

9. The decoration of claim 5, further comprising a backing, wherein said backing is attached to said thermoplastic material such that said molding tool is retained between said thermoplastic material and said backing.

10. The decoration of claim 9, wherein said backer is card stock.

11. A method of producing a relief image, comprising:
a. indicating one or more elements of a base image to be in relief;
b. indicating a subset of the one or more elements of the previous step to be in relief from the one or more elements of the previous step;
c. repeating step b until all elements corresponding to the desired relief image are indicated;
d. cutting each element from a substrate;
e. aligning, stack, and attach each of the one or more elements atop the one or more elements of the previous step, forming a molding tool;
f. aligning said molding tool on a backer;
g. printing said base image on a material capable of forming and holding a form;
h. aligning said base image on said material capable of forming and holding a form with said molding tool;
i. forming said material capable of forming and holding a form against said molding tool;
j. attaching said material capable of forming and holding a form to said backer using an attachment means, whereby said molding tool is retained between said material capable of forming and holding a form and said backer.

12. The method of producing a relief image of claim 11, wherein said attachment means is adhesive.

13. The method of producing a relief image of claim 11, wherein said material capable of forming and holding a form is plastic, styrene, PVC, or PET.

14. The method of producing a relief image of claim 11, wherein said material capable of forming and holding a form is laminated or coated.

15. The method of producing a relief image of claim 11, wherein said substrate is an inexpensive, disposable material.

16. The method of producing a relief image of claim 15, wherein said substrate is wood, cardboard, foam or plastic.
